(19) United States
(12) Patent Application Publication
(10) Pub. No.: US 2009/0068381 A1
(43) Pub. Date: Mar. 12, 2009

(54) POLARIZING SHEET

(76) Inventors: Chun-Chieh Yi, Taoyuan County (TW); Po-Tung Lai, Yun-Lin County (TW); Kun-Hsuan Yang, Taoyuan County (TW); Yu-Hong Chen, Changhua County (TW)

Correspondence Address: NORTH AMERICA INTELLECTUAL PROPERTY CORPORATION, P.O. BOX 506, MERRIFIELD, VA, 22116, US

(21) Appl. No.: 11/946,051

(22) Filed: Nov. 28, 2007

(30) Foreign Application Priority Data
Sep. 12, 2007 (TW) 096134087

(51) Int. Cl. C09K 19/00

(52) U.S. Cl. 428/1.31

(57) ABSTRACT

The polarizing sheet has a polarizer, a first protection layer disposed on a side of the polarizer, a first adhesive layer disposed between the polarizer and the first protection layer, a second protection layer disposed on the other side of the polarizer, and a second adhesive layer disposed between the polarizer and the second protection layer, wherein both the first adhesive layer and the second adhesive layer have an antistatic material.

### BACKGROUND OF THE INVENTION

1. Field of the Invention

The present invention relates to a polarizing sheet, and more particularly, to a polarizing sheet having an antistatic ability.

2. Description of the Prior Art

In the liquid crystal display, a polarizing sheet is one of essential components of the liquid crystal display, and the function thereof is to polarize light penetrating therethrough so that the light has polarization. For this reason, the liquid crystal display can utilize the polarized light combined with a twisted feature of the liquid crystal molecule to control whether the light passes therethrough or not and the displaying performance of grey signal. In recent years, with the liquid crystal display being generally applied to the electronic equipments such as a computer screen, a mobile phone or a liquid crystal television, even to an outside large display board, the requirement is therefore larger and larger.

Please refer to FIG. 1. FIG. 1 is a cross-sectional schematic diagram illustrating a polarizing sheet. As shown in FIG. 1, conventional polarizing sheet 10 comprises a polyvinyl alcohol (PVA) film 12, two protection layers 14, 16 respectively disposed on two sides of PVA film 12, and two adhesive layers 18, 20 respectively disposed between the PVA film 12 and the protection layers 14, 16 and utilized to bond the protection layers 14, 16 and the PVA film 12. In addition, the polarizing sheet 10 further comprises a pressure-sensitive adhesive film 22 adhering to another side of the protection layer 14 opposite to the PVA film 12, a release film 24 adhering to another side of the pressure-sensitive adhesive film 22 opposite to the protection layer 14, and a surface protection film 26 adhering to another side of the protection layer 16 opposite to the PVA film 12.

However, during manufacturing process of the liquid crystal panel, both bonding the polarizing sheet on the liquid crystal panel and releasing the surface protection film of the polarizing sheet produce static electricity. With the size of the liquid crystal panel being larger and larger, the residues of the static electricity are larger so as to easily cause micro matrix electrodes of the liquid crystal display to be damaged by the static electricity. The problem of the residues of the static electricity also causes the polarizing sheet and the optical film of the backlight module to be attracted to each other, so that the phenomenon of uneven color called mura easily happens. Hence, to improve the problem of the residues of the static electricity becomes an essential subject that the industries give every effort to improve.

### SUMMARY OF THE INVENTION

It is therefore an object to provide an antistatic polarizing sheet to prevent the residues of the static electricity during the adhering and releasing steps.

According to the claimed invention, a polarizing sheet is provided. The polarizing sheet includes a polarizer; a first protection layer disposed on a side of the polarizer; a first adhesive layer disposed between the polarizer and the first protection layer; a second protection layer disposed on another side of the polarizer; and a second adhesive layer disposed between the polarizer and the second protection layer, wherein both the first adhesive layer and the second adhesive layer include an antistatic material.

According to the above-mentioned, the polarizing sheet provided by the present invention includes the adhesive layer having an antistatic material. The antistatic material can reduce the surface resistance of the adhesive layer. And then, the present invention disposes the adhesive layer on two sides of the polarizer, so that not only the residues of the static electricity produced during the step of adhering the polarizing sheet on the liquid crystal panel can be reduced, but also the residues of the static electricity produced during the step of releasing the surface protection film from the polarizing sheet can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional schematic diagram illustrating a polarizing sheet.

FIG. 2 is a cross-sectional schematic diagram illustrating a polarizing sheet according to an embodiment of the present invention.

FIG. 3 is test results of the surface resistance of the adhesive layer in the present invention.

FIG. 4 through FIG. 9 are cross-sectional schematic diagrams illustrating polarizing sheets according to other embodiments of the present invention.

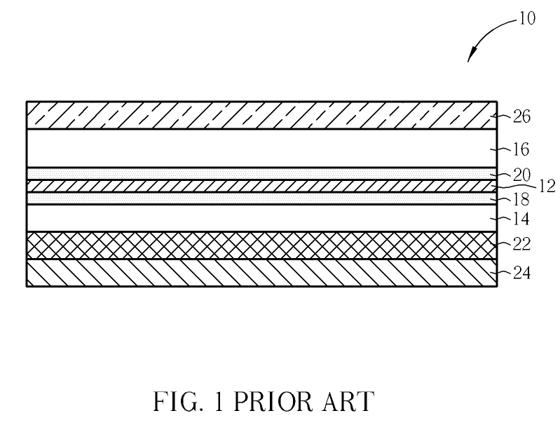

### DETAILED DESCRIPTION

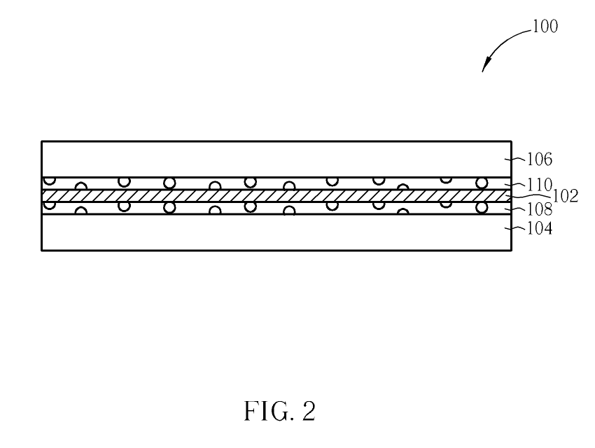

Please refer to FIG. 2. FIG. 2 is a cross-sectional schematic diagram illustrating a polarizing sheet according to an embodiment of the present invention. As shown in FIG. 2, the polarizing sheet 100 includes a polarizer 102, two protection layers 104, 106, and two adhesive layers 108, 110. The polarizer 102 has a polarizing feature, and the polarizer 102 can be a polyvinyl alcohol (PVA) film, but is not limited to this. The polarizer 102 can include chemical compositions with the polarizing feature. In this embodiment, the polarizer 102 takes the PVA film as an example, but is not limited to this. The protection layers 104, 106 are respectively disposed on two sides of the polarizer 102, and the adhesive layers 108, 110 are respectively disposed between the polarizer 102 and the two protection layers 104, 106 and utilized to bond the protection layers 104, 106 respectively on the two sides of the polarizer 102. The protection layers 104, 106 include triacetyl cellulose (TAC), diacetyl cellulose (DAC), polyethylene terephthalate (PET), cycloolefin polymer (COP), cycloolefin copolymer (COC), polycarbonate (PC) or similar thereto, and the protection layers 104, 106 are mainly utilized to support the polarizer 102 so as to prevent the polarizer 102 from shrinking and to protect the polarizer 102. In addition, it should be noted that the adhesive layers 108, 110 of this embodiment are different from the conventional adhesive layers. The difference is that the adhesive layers 108, 110 of this embodiment include an antistatic material, so that the static electricity produced during the steps of releasing the release film and the surface protection film or other steps can be neutralized so as to reduce the residues of the static electricity. Therefore, in displaying situation, the phenomenon of uneven color called mura produced by the residues of the static electricity on the liquid crystal panel can be prevented.

The antistatic material of this embodiment includes a metal salt, a conducting polymer or a combination thereof. The metal salt has an ionic bond, and preferably has lower lattice energy and higher solubility, such as lithium perchlorate (LiClO₄). The metal salt includes a cation and an anion. The cation includes Li⁺, Na⁺, K⁺, Rb⁺ or a combination thereof, and the anion is preferably an anion with larger ionic radius, such as ClO₄⁻, AsF₆⁻, PF₆⁻, BF₄⁻ or a combination thereof, but is not limited thereto. The metal salt also can be other similar ion-conducting additives. In addition, the conducting polymer includes a polymer, and chemical formula of the polymer is —[CₙH₂ₙ—X—CₘH₂ₘ—Y]—, wherein n=2-5, m=2-5, X is oxygen, nitrogen, or sulfur atom, Y is oxygen, nitrogen, or sulfur atom, and X and Y provide lone pair electrons. The conducting polymer is preferably a cross-linked copolymer of polypropylene oxide (PPO) and polyethylene oxide (PEO), but is not limited thereto. The conducting polymer also can be a polymer composed of identical monomer, such as PPO or PEO.

Furthermore, it should be noted that the adhesive layer 108, 110 of this embodiment is disposed on the two sides of the polarizer 102, so that not only the problem of the static electricity produced during releasing the surface protection film can be efficiently solved, but also the problem of the static electricity produced during releasing the release film can be solved. In addition, the adhesive layers 108, 110 not only have an antistatic ability, but also has an ability of bonding the protection layers 104, 106 and the polarizer 102. The adhesive layers include polyvinyl alcohol (PVA) polymer, polyurethane (PU) or UV-curing resin curable by radiation of UV light. Besides, the adhesive layers 108, 110 further include a cross-linking agent, a hydrochloric acid (HCl), an organic solvent and water. The organic solvent has better dissolving ability with the cation and the anion so as to be utilized to dissolve the antistatic material, and the organic solvent includes an alcohol. The water can be utilized to dissolve the PVA powders. The cross-linking agent includes a glyoxal. Therefore, because the polarizing sheet 100 of this embodiment does not need to dispose an extra antistatic layer thereon, the present invention also has an advantage of saving cost. It should be noted that the surface resistance of the adhesive layers 108, 110 with the antistatic material should be in the range between 10⁶ and 10¹² Ω/unit area so as to have the antistatic ability. The quantity of the antistatic material can be adjusted according to the requirement of the surface resistance.

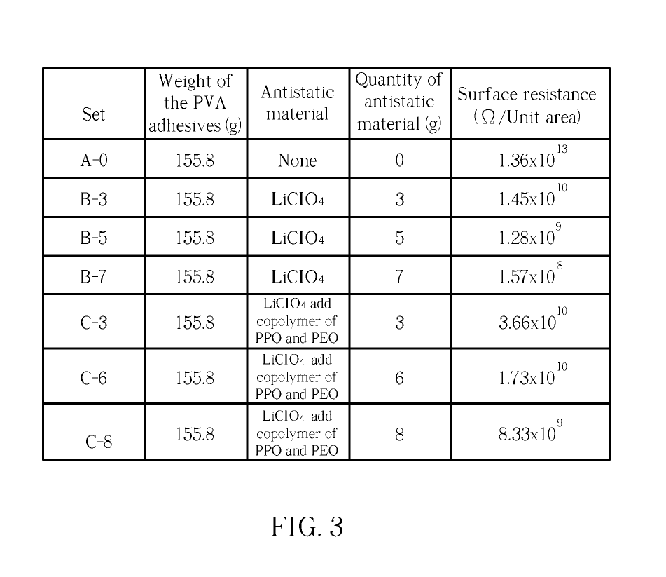

In addition, in order to explicitly illustrate the antistatic ability of the adhesive layer, an example is utilized to illustrate test results of the antistatic ability of the adhesive layer of the present invention. Please refer to FIG. 3. FIG. 3 is test results of the surface resistance of the adhesive layers according to the present invention. In the test of this embodiment, the PVA, the cross-linking agent, the HCl, the organic solvent and the water have a fixed proportion, and the proportion of each set is the same. In addition, the weight of the fixed proportion of the PVA, the cross-linking agent, the hydrochloric acid, the organic solvent and water (represented by weight of the PVA adhesives) is 155.8 grams. In these test results, the set of A-0 is an adhesive layer including no added antistatic material, and the surface resistance of the adhesive layer in the test result of A-0 is 1.36×10¹³ Ω/unit area; the set of B-3 is an adhesive layer including 3 grams of added antistatic material of LiClO₄, and the surface resistance of the adhesive layer in the test result of B-3 is 1.45×10¹⁰ Ω/unit area; the set of B-5 is an adhesive layer including 5 grams of added antistatic material of LiClO₄, and the surface resistance of the adhesive layer in the test result of B-5 is 1.28×10⁹ Ω/unit area; the set of B-7 is an adhesive layer including 7 grams of added antistatic material of LiClO₄, and the surface resistance of the adhesive layer in the test result of B-7 is 1.57×10⁸ Ω/unit area; the set of C-3 is an adhesive layer including 3 grams of added antistatic material of LiClO₄ added copolymer of PPO and PEO, and the surface resistance of the adhesive layer in the test result of C-3 is 3.66×10¹⁰ Ω/unit area; the set of C-6 is an adhesive layer including 6 grams of added antistatic material of LiClO₄ added copolymer of PPO and PEO, and the surface resistance of the adhesive layer in the test result of C-6 is 1.73×10¹⁰ Ω/unit area; the set of C-8 is an adhesive layer including 8 grams of added antistatic material of LiClO₄ added copolymer of PPO and PEO, and the surface resistance of the adhesive layer in the test result of C-8 is 8.33×10⁹ Ω/unit area. Therefore, according to the test results, the surface resistances of the adhesive layers including added antistatic material are in the range between 10⁶ Ω/unit area and 10¹² Ω/unit area, but the surface resistance of the adhesive layer including no added antistatic material is over the range between 10⁶ Ω/unit area and 10¹² Ω/unit area. This means that the adhesive layer including added antistatic material has an antistatic ability, so that the antistatic ability of the adhesive layer including added antistatic material is obviously improved.

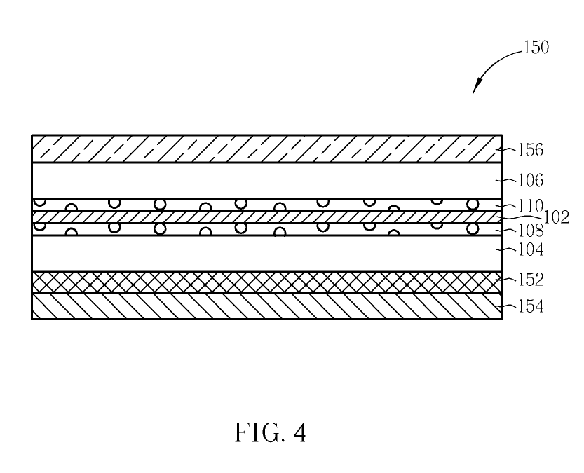

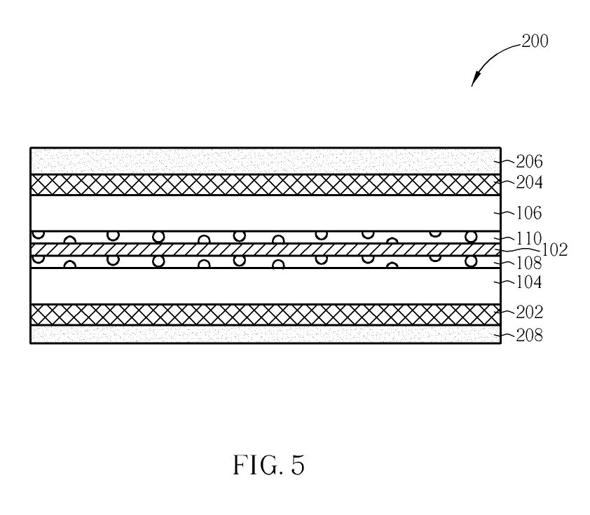

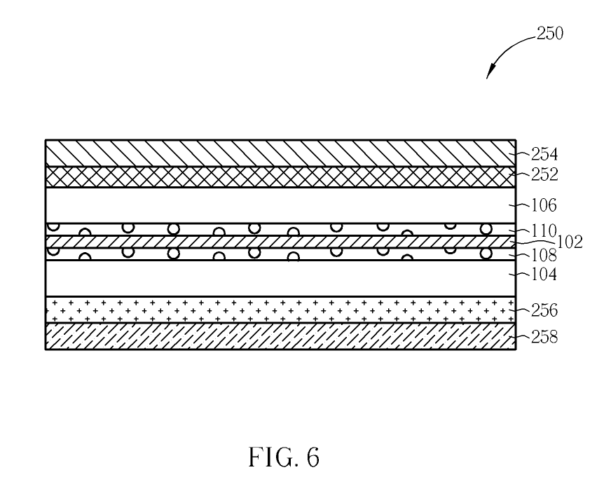

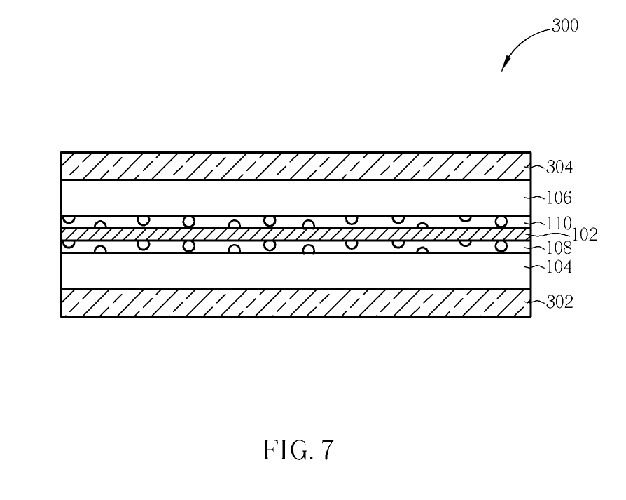

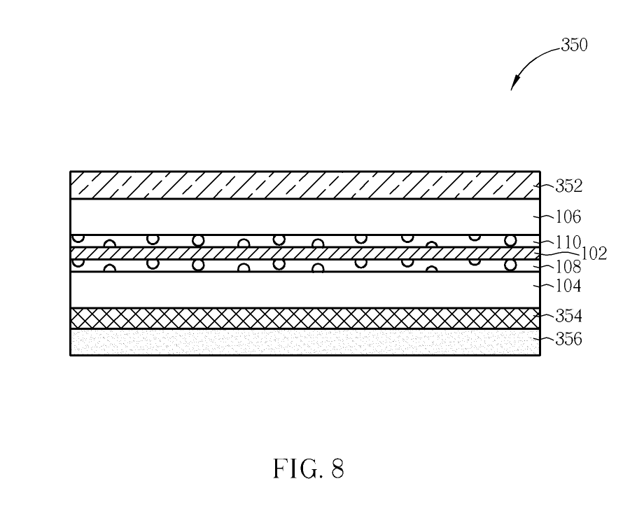

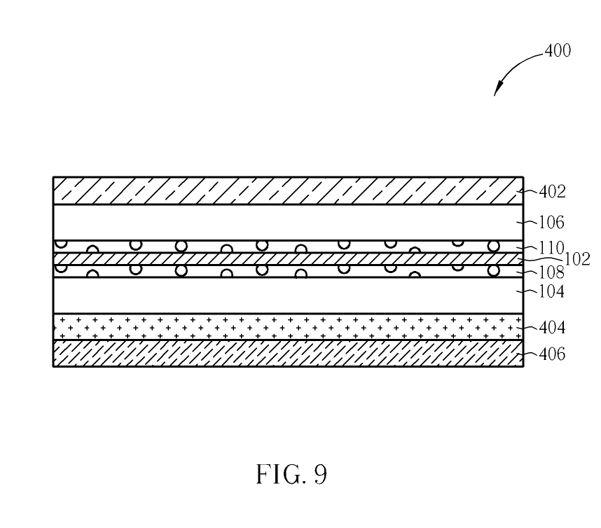

The polarizing sheet of the present invention can have different embodiments according to different applications, so that the polarizing sheet can satisfy different kinds of using requirements. Please refer to FIG. 4 through FIG. 9. FIG. 4 through FIG. 9 are cross-sectional schematic diagrams illustrating polarizing sheets according to other embodiments of the present invention. To more easily compare the differences between each embodiment, the same partial devices use the same reference numerals as the embodiment of FIG. 2. As shown in FIG. 4, a polarizing sheet 150 is a transmissive polarizing sheet further comprising a pressure-sensitive adhesive film 152 adhering to another side of the protection layer 104 opposite to the polarizer 102, a release film 154 adhering to another side of the pressure-sensitive adhesive film 152 opposite to the protection layer 104, and a protective film 156 adhering to another side of the protection layer 106 opposite to the polarizer 102. As shown in FIG. 5, a polarizing sheet 200 is a reflective polarizing sheet further comprising two pressure-sensitive adhesive films 202, 204 respectively disposed on another sides of the protection layer 104, 106 opposite to the adhesive layer 108, 110, a release film 206 disposed on another side of one pressure-sensitive adhesive film 204 opposite to the protection layer 106, and a reflective sheet 208 disposed on another side of the other pressure-sensitive adhesive film 202 opposite to the protection layer 104. As shown in FIG. 6, a polarizing sheet 250 is a transflective polarizing sheet further comprising a pressure-sensitive adhesive film 252 disposed on another side of one protection layer 106 opposite to the adhesive layer 110, a release film 254 disposed on another side of the pressure-sensitive adhesive film 252 opposite to the protection layer 106, a transflective layer 256 disposed on another side of the other protection layer 104 opposite to the adhesive layer 108, and a lightless PET sheet 258 disposed on the transflective layer 256 opposite to the protection layer 104. As shown in FIG. 7, a polarizing sheet 300 is a non-adhesive transmissive polarizing sheet further comprising two surface protection films 302, 304 respectively disposed on another sides of the protection layers 104, 106 opposite to the adhesive layers 108, 110. As shown in FIG. 8, a polarizing sheet 350 is a non-adhesive reflective polarizing sheet further comprising a surface protection film 352 disposed on another side of one protection layer 106 opposite to the adhesive layer 110, a pressure-sensitive adhesive film 354 disposed on another side of the other protection layer 104 opposite to the adhesive layer 108, and a reflective sheet 356 disposed on another side of the pressure-sensitive adhesive film 354 opposite to the protection layer 104. As shown in FIG. 9, a polarizing sheet 400 is a non-adhesive transflective polarizing sheet further comprising a surface protection film 402 disposed on another side of one protection layer 106 opposite to the adhesive layer 110, a transflective layer 404 disposed on another side of the other protection layer 104 opposite to the adhesive layer 108, and a lightless PET sheet 406 disposed on another side of the transflective layer 404 opposite to the protection layer 104.

In conclusion, the polarizing sheet provided by the present invention includes the adhesive layer having an antistatic material. The antistatic material can reduce the surface resistance of the adhesive layer. And then, the present invention disposes the adhesive layer on two sides of the polarizer, so that not only the residues of the static electricity produced during the step of adhering the polarizing sheet on the liquid crystal panel can be reduced, but also the residues of the static electricity produced during the step of releasing the surface protection film from the polarizing sheet can be reduced. In addition, the adhesive layer further has a feature of adhesion, so that the polarizer and the protection layer can be adhered to each other without an added antistatic layer. Hence, the present invention also can save the manufacturing cost.

Those skilled in the art will readily observe that numerous modifications and alterations of the device and method may be made while retaining the teachings of the invention.

What is claimed is:

1. A polarizing sheet, comprising:
a polarizer;
a first protection layer disposed on a side of the polarizer;
a first adhesive layer disposed between the polarizer and the first protection layer;
a second protection layer disposed on another side of the polarizer; and
a second adhesive layer disposed between the polarizer and the second protection layer, wherein both the first adhesive layer and the second adhesive layer comprise an antistatic material.

2. The polarizing sheet of claim 1, wherein both the first adhesive layer and the second adhesive layer further comprise polyvinyl alcohol (PVA), polyurethane (PU) or UV-curing resin.

3. The polarizing sheet of claim 1, wherein both the first adhesive layer and the second adhesive layer further comprise an organic solvent, and the organic solvent dissolves the antistatic material.

4. The polarizing sheet of claim 3, wherein the organic solvent is an alcohol.

5. The polarizing sheet of claim 1, wherein the surface resistances of both the first adhesive layer and the second adhesive layer are between 10⁶ and 10¹² Ω/unit area.

6. The polarizing sheet of claim 1, wherein the antistatic material comprises a metal salt.

7. The polarizing sheet of claim 6, wherein the metal salt comprises Li⁺, Na⁺, K⁺, Rb⁺ or a combination thereof.

8. The polarizing sheet of claim 6, wherein the metal salt comprises ClO₄⁻, AsF₆⁻, PF₆⁻, BF₄⁻ or a combination thereof.

9. The polarizing sheet of claim 1, wherein the antistatic material comprises a conducting polymer.

10. The polarizing sheet of claim 9, wherein the conducting polymer comprises a polymer, and the chemical formula of the polymer is —[CₙH₂ₙ—X—CₘH₂ₘ—Y]—, wherein n=2-5, m=2-5, X is oxygen, nitrogen, or sulfur atom, and Y is oxygen, nitrogen, or sulfur atom.

11. The polarizing sheet of claim 1, wherein the first protection layer and the second protection layer comprise triacetyl cellulose (TAC), diacetyl cellulose (DAC), polyethylene terephthalate (PET), cycloolefin polymer (COP), cycloolefin copolymer (COC) or polycarbonate (PC).

12. The polarizing sheet of claim 1, wherein the polarizer is a PVA film.

13. The polarizing sheet of claim 1, further comprising a surface protection film disposed on another side of the second protection layer opposite to the polarizer.

14. The polarizer sheet of the claim 1, further comprising a pressure-sensitive adhesive film disposed on another side of the first protection layer opposite to the polarizer.

15. The polarizer sheet of the claim 14, further comprising a release film disposed on another side of the pressure-sensitive adhesive film opposite to the first protection layer.
